(19) United States
(12) Patent Application Publication
(10) Pub. No.: US 2017/0320542 A1
(43) Pub. Date: Nov. 9, 2017

(54) A FLUID MOTOR AND A FLUID PUMP

(71) Applicant: GENIUS VELO LIMITED, Middlesex (GB)

(72) Inventor: Teklemichael Sebhatu, London (GB)

(73) Assignee: GENIUS VELO LIMITED, MIDDLESEX (GB)

(21) Appl. No.: 15/535,031

(22) PCT Filed: Dec. 10, 2015
(86) PCT No.: PCT/GB2015/053807

§ 371 Date: Jun. 9, 2017

(30) Foreign Application Priority Data
Dec. 10, 2014 (GB) 1421986.9

(51) Int. Cl. B62M 19/00; F16H 39/01; F01B 3/00; B60B 27/00; F16H 39/02; F01B 3/04

(52) U.S. Cl. CPC B62M 19/00; F16H 39/02; F16H 39/01; F01B 3/04; B60B 27/0015; F01B 3/0023; F01B 3/0005; F01B 3/0085; B60Y 2200/13

(57) ABSTRACT

A fluid machine for a pneumatic or hydraulic drive system, said fluid machine being able to work as a fluid motor or as a fluid pump, comprising: at least two piston assemblies each comprising a piston means (110a-c), the at least two piston assemblies being operable to cause sequential reciprocating movement of the pistons means (110a-c); a drive member (120) rotatable about an axis and providing an annular, wave-like surface (122) extending at least partially radially to the axis, towards which the piston means (110a-c) project, wherein, in case of working as a fluid motor, the pistons means (110a-c) are arranged to drive rotation of the drive member (120) about the axis at least by a pushing action on said wave-like surface (122) or, in the case of working as a fluid pump, the piston means (110a-c) are arranged to cooperate with said wave-like surface (122) so that rotation of the drive member (120) drives sequential reciprocating motion of the piston means (110a-c).

### FIELD OF THE INVENTION

The invention relates to a fluid motor for a pneumatic or hydraulic drive system, and a fluid pump for such a system.

### BACKGROUND

Drive systems incorporating fluid motors and fluid pumps are known. The object of the present invention is to provide a fluid motor and a fluid pump that each operate more efficiently than known fluid motors and pumps.

### SUMMARY OF THE INVENTION

According to the present invention, there is provided a fluid motor for a pneumatic or hydraulic drive system, comprising: at least two piston assemblies each comprising a corresponding piston means, the at least two piston assemblies being operable to cause sequential reciprocating movement of the pistons means; a drive member rotatable about an axis and providing a surface radial to the axis and extending continuously around, onto which the pistons means may project; wherein the pistons means are arranged to drive rotation of the member about the axis at least by cooperating with said wave-like surface.

According to the present invention, there is further provided a fluid pump for a pneumatic or hydraulic drive system, comprising: a drive member rotatable about an axis and providing an annular, wave-like surface extending at least partially radially to the axis; at least two piston assemblies each comprising a corresponding piston means, wherein the pistons means project towards the wave-like surface, wherein the at least two piston assemblies are arranged to cooperate so that rotation of the drive member about the axis drives sequential reciprocating motion of the piston means at least by a pushing action on said piston means.

Optional and/or preferred features of the present invention are defined in the dependent claims.

The fluid motor and the fluid pump improve upon fluid pumps and fluid motors disclosed in WO2014195666, providing more efficient transmission.

### BRIEF DESCRIPTION OF FIGURES

Embodiments of the present invention will now be described, by way of example only, with reference to the accompanying Figures in which:

FIG. 1 is a view of a hub assembly incorporating a fluid motor in an accordance with an embodiment, the hub assembly being in built form;

FIG. 2 is a side, exploded view of the hub assembly;

FIG. 3 is a perspective side, exploded view of the hub assembly;

FIG. 4 is a cross-sectional view of the hub assembly;

FIG. 5 is a view of a fluid pump in accordance with an embodiment;

FIG. 6 is a side, exploded view of the fluid pump;

FIG. 7 is a perspective side, exploded view of the fluid pump;

FIG. 8 is a view of the fluid pump in assembled form, with an outer casing and end plate absent; and

FIG. 9 is a view of cross-sectional view of the fluid pump in assembled form.

### DETAILED DESCRIPTION OF EMBODIMENTS

Like parts are denoted by like numerals throughout.

In the following, a hub assembly for a wheel of a bicycle incorporating a fluid motor in accordance with an embodiment will be described. A fluid pump operable by a pedalling action will also be described, which can be coupled to the fluid motor to drive rotation of the hub.

Certain terminology will be used in the following description for convenience and reference only, and should not be considered limiting. The term “fluid” encompasses both liquids and gases. In the context of hydraulic systems, this term should be considered to be a substantially incompressible flowable material such as a liquid or gel, for example oil. In the context of pneumatic systems, this term should be considered to be a gas, typically an inert gas such as nitrogen or air. A “forwards direction” is the angular direction of rotation in which a hub assembly or drive shaft of a fluid pump turns when the bicycle incorporating the hub assembly or the drive shaft is moving in a forwards direction.

The hub assembly to be described is intended for use in a bicycle, to drive a rear wheel of the bicycle. The hub assembly may alternatively be used in the front wheel of a bicycle. The fluid motor that is incorporated in the hub assembly has other applications. Application of a fluid motor in accordance with embodiments and/or a hub assembly in accordance with other embodiments is not limited to use in a bicycle. For example, embodiments may be used in a wheel of other kinds of vehicle such as motorcycles, scooters, cars, heavy goods vehicles and heavy equipment. “Heavy equipment” refers to heavy-duty vehicles, in particular those specifically designed for performing construction tasks, most frequently ones involving earthwork operations. Embodiments may also be used in other hydraulic systems where reduction or amplification of rotational force is desired, or where conversion of pressure to rotary motion is desired.

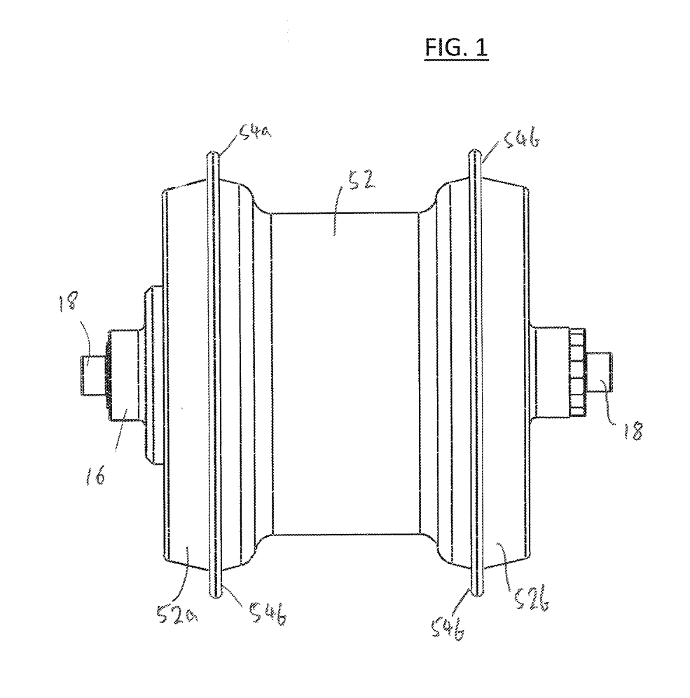

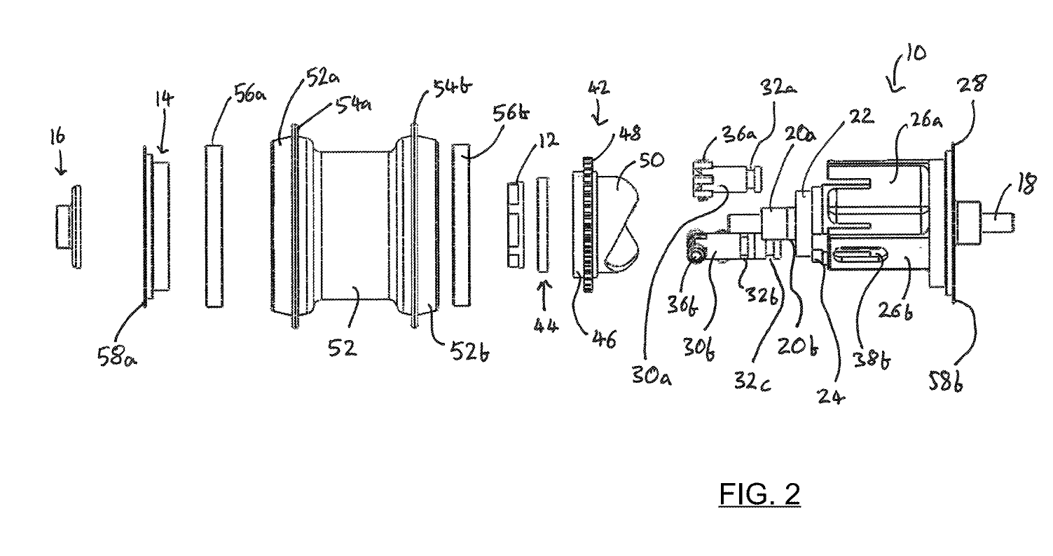

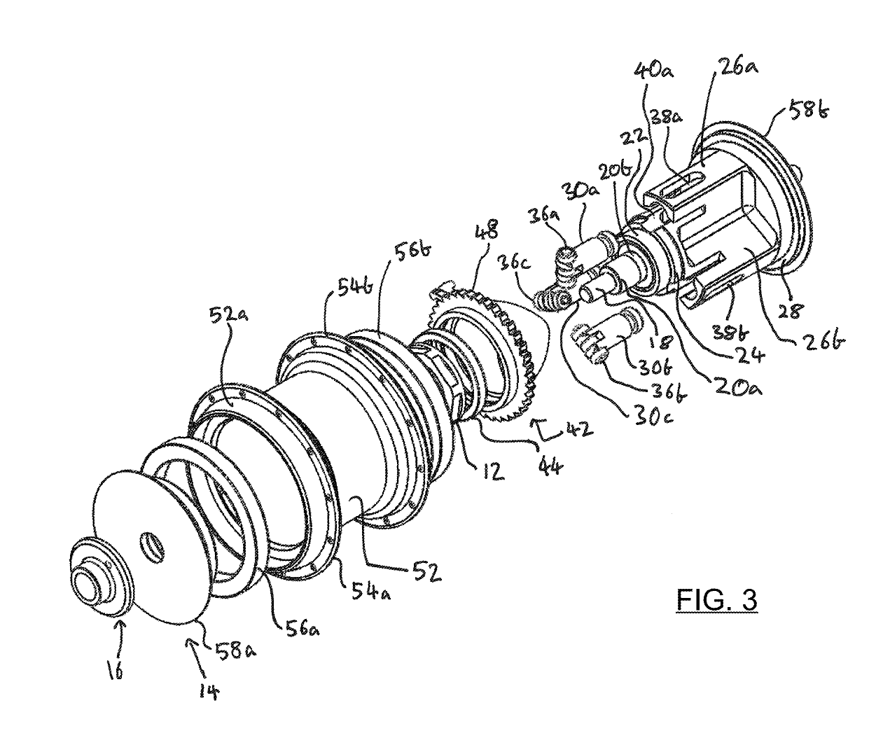

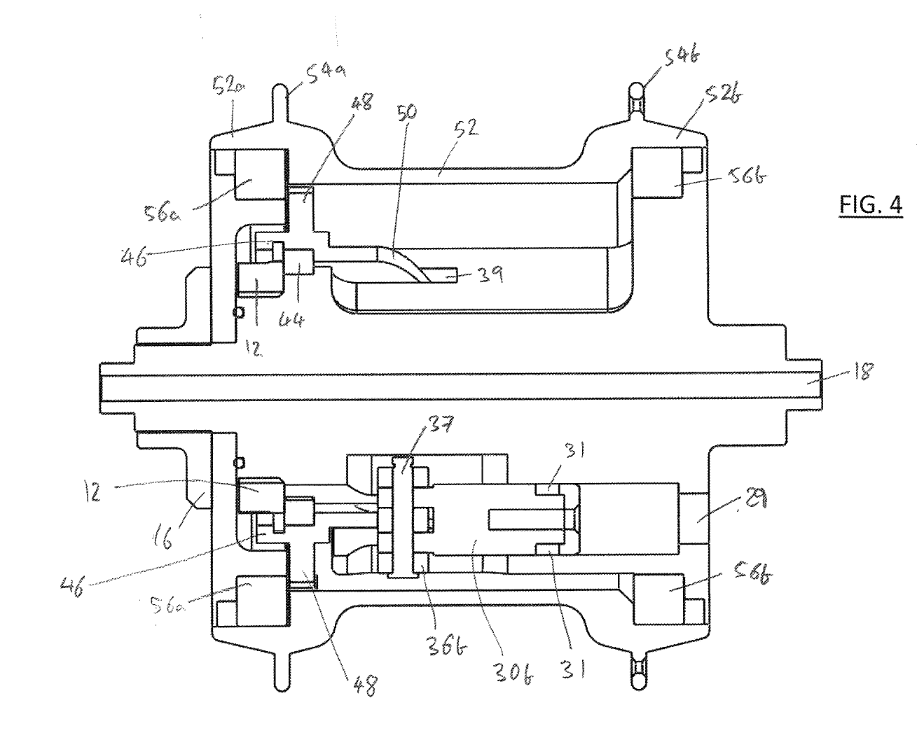

Referring to FIGS. 1 to 4, the hub assembly is configured for attaching to a frame of a bicycle. This may be done by welding, for example, or by means enabling quick release of a wheel from a bicycle. The hub assembly has some parts that are fixed relative to the frame, a motion conversion mechanism, and other parts that rotate relative to an axis of the hub assembly.

The fixed parts include a main structural member, indicated generally at 10, a threaded nut 12, a first end plate 14 and a threaded end piece 16. The main structural member 10 comprises a cylindrical rod 18, a first cylindrical block portion 20a, 20b of greater diameter than the rod 18, a second cylindrical block portion 22 of greater diameter than the first cylindrical block 20a, 20b, an annular stepped seat portion 24, three frame portions 26a-c and a second end plate 28. The main structural member is formed of a single piece, although it could be formed of multiple parts and assembled.

The cylindrical rod 18 extends from a first side of the hub assembly to the second side. First and second ends of the rod 18 extend for attachment to the frame of the bicycle. Each of the cylindrical parts mentioned above have as their central axis the axis of rotation of the rotatable parts of the hub assembly. The first block portion has a part 20a thereof adjacent the second block portion 22, which is threaded. The second block portion 22 has a threaded outer surface.

Each of the frame portions 26a-c form a cylinder portion, which partially define a respective fluid chamber. The second end plate 28 has three holes (one shown at 29) therein each enabling an external fluid-containing line (not shown) to sealingly connect with a corresponding one of the chambers so that the chamber and the line are in fluid communication. Each fluid-containing line is connected to a pressure generation system, which is configured to cause the fluid in each fluid-containing line to reciprocate or pulsate and thus move into and out of the corresponding chamber.

The motion conversion mechanism includes three pistons 30a-c spaced at angular intervals around the central axis of the hub assembly. The cylinder portions provided by the frame portions 26a-c and the pistons 30a-c are configured to cooperate so that each of the pistons 30a-c can reciprocate in a corresponding one of the cylinder portions. Each piston 30a-c has an annular groove 32a-c extending therearound in which a lip seal 31 is located to prevent egress of fluid from the chambers.

Each piston 30a-c has a body and a head end and is arranged for reciprocating movement parallel to the central axis. The head end has three roller pieces 36a-c held to a projection of the body by a pin 37. A first and second of the roller pieces extend each from a respective side of each piston and these engage with the corresponding frame portion 26a-c to support reciprocating movement thereof. The frame portions 26a-c provide, for each piston, a corresponding elongate slot 38a-c into which the first of these roller pieces extends to support reciprocating movement of the piston parallel to the axis. The frame portions 26a-c also provide, for each piston, a corresponding elongate recess 40a-c into which the second of these roller pieces extends to support reciprocating movement of the piston parallel to the axis. The frame portions 26a-c also having slits 39 therein enabling rotational movement of the drive cam 42, which is described in greater detail below.

The motion conversion mechanism also includes a drive cam indicated generally at 42, and an annular bearing assembly 44. The annular bearing assembly 44 is mounted on the stepped portion 24. The stepped portion 24 provides a cylindrical annular surface on which the annular bearing assembly 44 sits, such that an inner surface of the annular bearing assembly 44 and an outer cylindrical surface of the stepped portion are flush. A radial surface of the stepped portion 24 prevents movement of the annular bearing assembly 44 beyond the stepped portion towards the first cylindrical disc 28. The nut 12 is located on the second cylindrical block 22 by screw engagement, to prevent lateral movement of the annular bearing assembly 44 in the other direction. “Lateral” movement should herein be considered to be movement lengthwise of the central axis.

The drive cam 42 comprises a cylindrical portion 46, a circumferential ratcheting portion 48 and a driven portion 50. The drive cam 42 is located over the annular bearing assembly 44, so that the drive cam 42 can rotate on the annular bearing assembly. An inner surface of the cylindrical portion fits flush over the outer surface of the annular bearing assembly 44.

The driven portion 50 provides a wave-like surface against which the heads 36a-c of the pistons 30a-c project. The wave-like surface extends continuously around the axis to present an annular surface that faces in a direction parallel to the central axis. By “wave-like”, it should be understood that the surface extends smoothly around the central axis and the radial location of the surface changes along the central axis. The surface may vary sinusoidally, for example. There are two peaks and two troughs in the surface, although in other embodiments the number of peaks and troughs may differ. The pistons 30a-c and this surface are arranged to cooperate so that when the pistons are driven so as to extend repeatedly in a consecutive sequence, the pistons 30a-c drives rotational motion of the drive member 42 in a forwards direction.

The wave-like surface is sufficiently smooth as to allow movement of the surface against the pistons 30a-c. In other embodiments, rollers may not be provided and other means of maintaining low friction between the wave-like surface and the heads of the pistons may.

The annular bearing assembly 44 and the drive cam 42 are held in place on the threaded second block portion 22 by the nut 12. Thus, lateral movement of the drive cam 42 is prevented.

The hub assembly includes an outer sleeve 50. First and second spaced circumferential flanges 52a, 52b extend radially from the outer sleeve 50. Each has a plurality of regularly spaced holes therein to which spokes of a bicycle wheel may be secured. In other embodiments, spokes may not be required and the hub assembly may be otherwise integrated into a bicycle wheel. The outer sleeve comprises first and second cylindrical end portions 50a, 50b at which the diameter of the outer sleeve 50 is larger than over an intermediate portion thereof. This results in an annular stepped internal surface at each end of the outer sleeve 50. First and second annular sleeve bearing assemblies 56a, 56b are each sized to locate in the outer sleeve 50, so that each sleeve bearing assembly 56a, 56b is located flush against a respective one of the stepped internal surfaces. The sleeve bearing assemblies 56a, 56b are located to have the central axis at their axis and function to enable the outer sleeve 50 to rotate freely therearound.

The outer sleeve 50 is arranged to contain the motion conversion mechanism. The first and second ends 52a, 52b of the outer sleeve 52 are respectively arranged to locate against the first and second end plates 14, 28. This is achieved by each of the first and second end plates 14, 28 having an annular flange 58a, 58b extending around a circumferential outer surface thereof. Respective inner surfaces of the first and second ends 52a, 52b of the outer sleeve 50 respectively locate flush on the circumferential outer surface of the first and second end plates 14, 28. The flanges 58a, 58b prevent lateral movement of the outer sleeve 50.

The threaded end piece 16 is secured to the threaded part 22b of the first block portion by screw engagement. To this end, both are sized appropriately. The threaded end piece 16 is secured against the first end plate 14. The threaded end piece 16 is secured to press against the first end plate 14, which presses against the first sleeve bearing assembly 56b. The first sleeve bearing assembly 56a presses against a radial part of the stepped internal surface of the first end of the outer sleeve 52. The second sleeve bearing assembly 56b is pressed by a radial part of the other stepped internal surface at the second end 52b of the outer sleeve. This presses against the flange 58b of the second end plate 28. The result is that lateral movement of the outer sleeve 52 is prevented, but rotational movement of the outer sleeve 52 is permitted, subject to operation of the motion conversion mechanism.

Although not shown, the outer sleeve 52 has an inwardly directed pawl that engages with the ratcheted portion 48 of the drive cam 42. This provides a freewheel mechanism for the hub assembly, such that the hub can be rotated from its exterior in a forwards direction without engaging the interior motion conversion mechanism. Alternative freewheel mechanisms are known in the art and may be alternatively employed in other embodiments. Alternatively, in embodiments a freewheel mechanism may be absent and the drive cam 42 may be fixedly coupled or integrally formed with the outer sleeve 52 so that one cannot be moved without the other moving.

In operation, fluid is provided sequentially to each of the fluid chambers via the fluid-containing lines. This causes each of the pistons 30a-c to sequentially extend and retract. Extension of the pistons 30a-c against the wave-like surface causes rotational motion of the drive cam 42 in a forwards direction. Rotation of the drive cam 42 in the forwards direction causes the freewheel mechanism to engage the outer sleeve 52, causing rotation of the outer sleeve, and thus a wheel of which the hub assembly forms part.

It will be appreciated by the skilled person that various modifications may be made to the hub assembly described above and the fluid motor incorporated in the hub assembly.

As the skilled person will appreciate, in other embodiments the arrangement of the pistons and the wave-like surface may differ. Preferably but not essentially, the wave-like surface and the pistons may be configured so that the sequence of reciprocating movement of the pistons 30a-c causes rotational movement of the drive member 42 in a forwards direction only.

A pressure generating system may be configured to cause fluid in each fluid containing line to move into the corresponding chamber in turn. Alternatively, depending on the shape of the drive cam, the hub assembly may be configured so that more than one piston pushes the drive cam at one time. It will be clear to the skilled person that there are various ways that a number of pistons may be configured to cooperate with the drive cam to cause it to rotate in a desired direction.

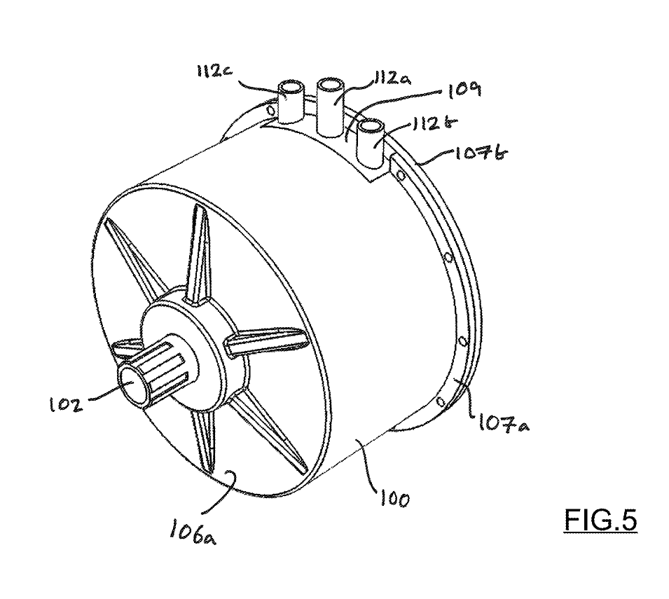

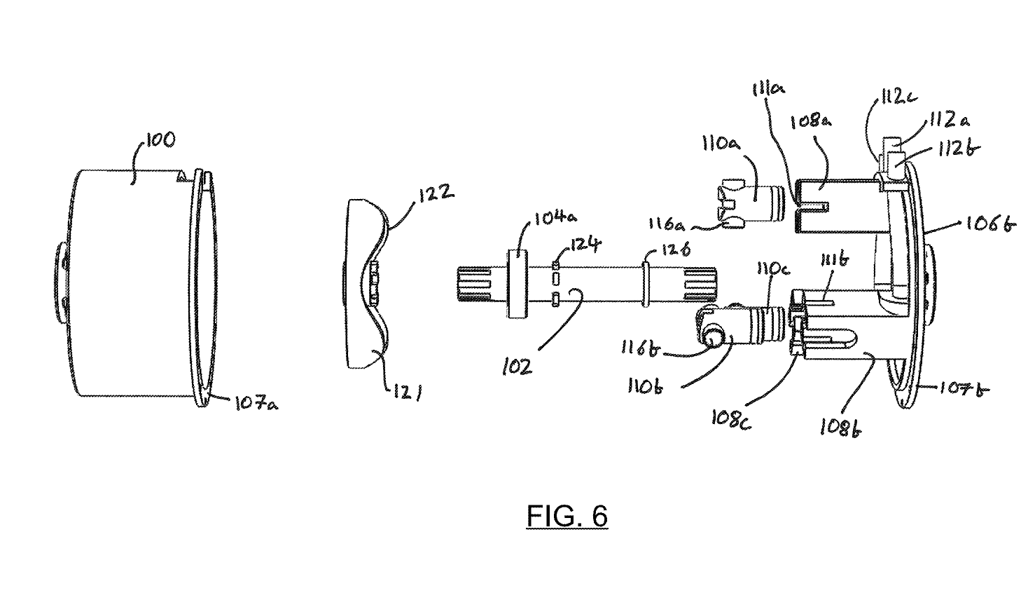

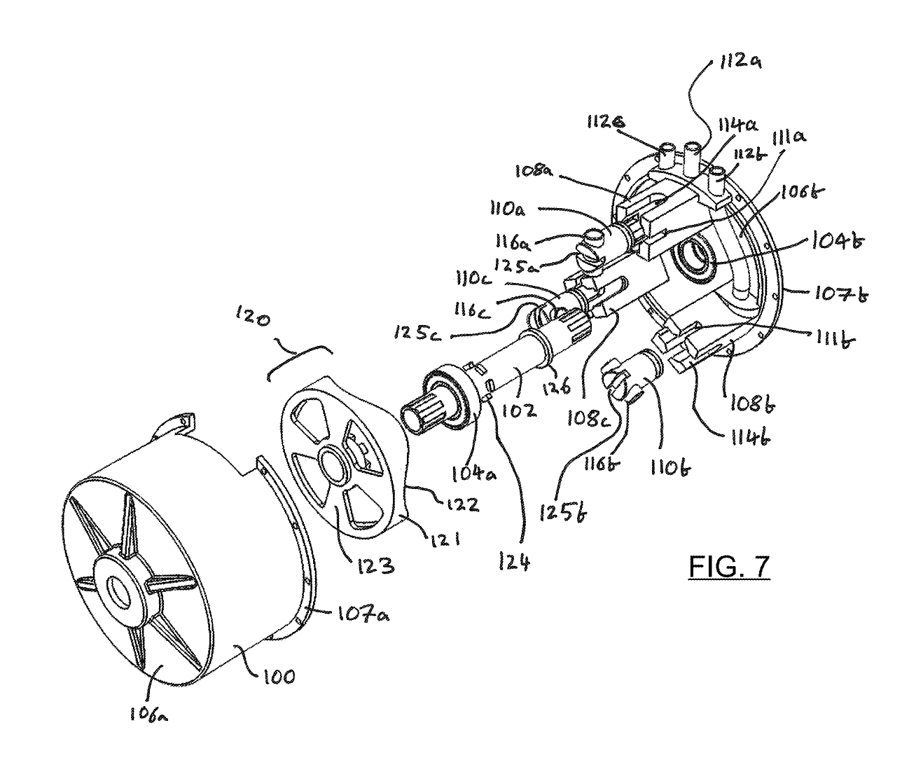

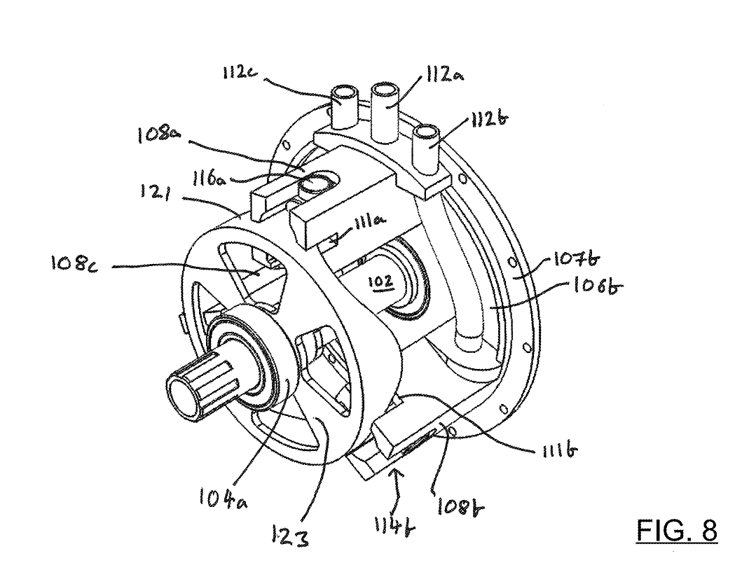

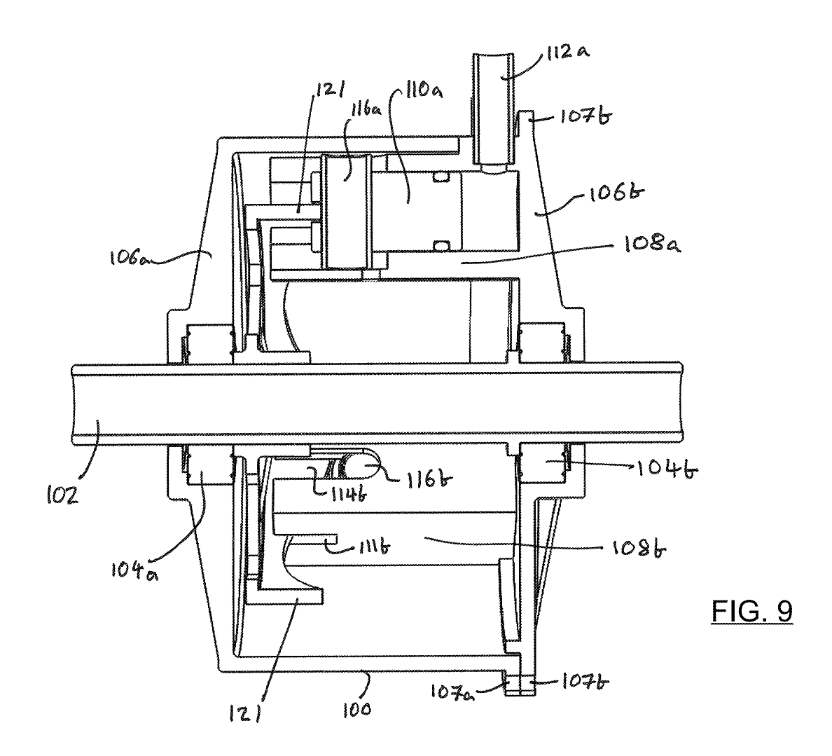

A fluid pump is now described with reference to FIGS. 5 to 9, which may be used with the fluid motor described above. The fluid pump works using similar principles to the fluid motor described above.

The fluid pump includes some parts that are fixed relative to the frame of a bicycle, a motion conversion mechanism, and rotating parts. Fixed parts comprise a cylindrical casing 100, first and second annular bearing assemblies 104a, 104b, and first and second annular end plates 106a, 106b. A rotatable drive shaft 102 extends through the first and second annular bearing assemblies 104a, 104b. The first and second annular bearing assemblies 104a, 104b carry the drive shaft 102 and allow low friction rotation of the drive shaft 102 about its central axis. The first and second annular end plates 106a, 106b extend inwardly from respective circular end edges of the cylindrical casing 100 to encase the first and second annular bearing assemblies 104b. The first annular end plate 106a and the cylindrical casing 100 are formed of a single piece, although this need not be the case. The second end plate 106b and an end of the cylinder casing remote from the first end plate 106a have radially extending flanges 107a, 107b,save for where a window is provided in the cylindrical casing 100 for passage of fluid transmission lines. These flanges are arranged to lie flush one against the other and for attachment to each other. Holes in each flange enable the flanges to be bolted together, although the flanges may be otherwise attached together, for example by riveting.

The second annular end plate 106b has three piston assemblies mounted thereon. Each piston assembly includes a cylinder portion 108a-c and a corresponding piston 110a-c. Each cylinder portion 108a-c has a chamber therein defined by the walls of the cylinder portion 108a-c and an end of the respective piston 110a-c. Each cylinder portion 108a-c has an aperture therein forming an inlet/outlet to the chamber, to which a fluid-containing line 112a-c is sealingly attached. The cylinder portions 108a-c are integrally formed with the second end plate 106b, although they may be formed separately and attached. The fluid-containing lines 112a-c extends each from the respective cylinder portion 108a-c and are held in a mount 109. The mount 109 is integrally formed with the second end plate 106b, although may be formed separately and then attached. When the fluid pump is mounted on a bicycle frame, the fluid-containing lines preferably run along a chain stay to the fluid motor. The fluid-containing lines may run inside the chain stays. The chain stays may indeed be shaped to form part of the fluid-containing lines. Alternatively, the fluid-containing lines may extend though other tubes of a bicycle frame.

Each piston 110a-c is mounted to allow reciprocating movement in the corresponding cylinder portion 108a-c. Each cylinder portion 108a-c has a pair of facing slots 114a-c in sides thereof, extending parallel to the axis of the drive shaft 102. Each piston 110a-c has a pin 116a-c extending therethrough. Each end of each pin 116a-c is moveable in a respective slot of the corresponding cylinder portion 108a-c, to guide and support movement of the pistons 110a-c parallel to the axis of the drive shaft 102. In variants, the piston 110a-c may have square cross-section, for example, to stop rotation of the pistons as they reciprocate in the cylinder portions 108a-c.

The drive shaft 102 is configured at each end thereof for mounting of an end of a crank arm (not shown). Where a crank arm is mounted, a pedal (also not shown) is also operatively attached to the other end of the crank arm to enable rotation of the drive shaft 102 with a pedalling action. The ends of the drive shaft 102 are shown as splined, but may be otherwise shaped for engagement of the crank arm.

The fluid pump is for mounting in a bottom bracket of a bicycle frame. The bottom bracket may be larger than a conventional standard bottom bracket to accommodate the cylindrical casing 100. Alternatively, the fluid pump may be modified from that shown in the figures so that it fits in a bottom bracket of a standard size.

A motion conversion means includes a cam member 120 and the pistons 110a-c. The cam member 120 is mounted on and rotatable about the drive shaft 102. The cam member 120 is formed of a part-cylindrical piece 121 and a mounting portion 123. The part-cylindrical piece 121 extends around the drive shaft 102 coaxially therewith. The mounting portion 123 mounts the part-cylindrical piece 121 on the drive shaft 102. The part-cylindrical piece 121 provides an annular wave-like surface 122. The wave-like surface is as characterised above in relation to the fluid motor. The annular surface 122 extends continuously around the drive shaft 102 coaxially therewith and faces near ends of the pistons 110a-c. The wave-like surface has a four peaks and troughs, although in other embodiments a greater or lesser number may be provided. The pistons 110a-c and the cam member 120 are respectively disposed so that rotation of the drive member 120 causes the annular surface 122 to sequentially drive the pistons 110a-c into their respective cylinder portions 108a-c.

The cylinder portions 108a-c have slits 111a-c therein located to enable the part-cylindrical piece 121 to pass therethrough to the extent appropriate. This aids compactness and rigidity of the fluid pump, while enabling the cylinder portions 108a-c to extend to provide support for the pistons 110a-c.

The ends of the pistons 110a-c near the annular surface 122 also have slits 125a-c therein (“piston slits”). An annular edge of the part-cylindrical piece 121 including a portion of the annular surface 122 engages in the piston slits 125a-c. This results in the portion of the annular surface 122 that pushes the pistons 110a-c abutting the pins of the pistons. The pins are rotatable about their axes. This aids smoothness of operation of the fluid pump. In a variant embodiment, the slit may not be present and the annular surface 122 may simply abut against an end of a respective body of the pistons 110a-c. The ends may be curved, for example to have a semi-circular cross-section, for the sake of smoothness of operation.

The cam member 120 is fixedly mounted onto the drive shaft 102. The drive shaft 102 has a number of projections extending circumferentially around it forming a spline 124. The mounting portion 123 has a plurality of projections for engaging with the spline 124, so that rotation of the drive shaft 102 causes rotation of the cam member 120. In variant embodiments, the cam member 120 is integrally formed with the drive shaft 102.

The mounting portion 123 is located between the spline 124 and the first annular bearing assembly 104a. An annulus 126 around the drive shaft 102 is located to abut against the second annular bearing assembly 104b. These parts are sized so that lateral movement along the drive shaft 102 is substantially prevented. The spline 124 and the annulus 126 are preferably integrally formed with the drive shaft 102.

In variant embodiments, the fluid pump may include a ratcheting assembly is configured so that rotation of the drive shaft 102 by a pedalling action in a forwards direction results in the drive shaft 102 turning in the same direction, whereas turning of the drive shaft 102 in the reverse direction does not.

In operation, the drive shaft 102 is rotated by a user of the bicycle with a pedalling action in a forwards direction. The rotation of the drive shaft 102 causes the cam member 120 to rotate about the axis of the drive shaft 102. As the annular surface 122 rotates, the annular surface pushes the pistons 110a-c into the respective cylinder portions 108a-c. When a piston 110a-c is pushed into the respective cylinder portion 108a-c, the end of the piston pushes fluid from the corresponding chamber. This results in a pulse in the fluid, which pushes a piston in the fluid motor to which the fluid pump is coupled.

Typically, the nature of the hydraulic system comprising the fluid pump and the fluid motor will result in each piston 110a-c rebounding from the respective cylinder portion 108a-c. In a variant, a spring or other resilient means may be provided so that each piston 108a-c is biased towards an extended position.

Thus, rotation of the cam member 120 results in repeated sequential movement of the pistons 110a-c into and out of the corresponding cylinder portions 108a-c, which causes reciprocating movement of fluid in the fluid-containing lines.

The pump may be operated other than by a pedalling action. The drive shaft 102 may be rotated by any suitable means, for example an electric motor, a wheel or rotor of a turbine.

Various modifications may be made to the above described embodiments, as will be clear to the skilled person.

As mentioned above, the fluid pump described with reference to FIGS. 1 to 4 and the fluid pump described with reference to FIGS. 5 to 9 may be used together, in a bicycle or, possibly in a modified form, in other applications. It should be understood that the hub assembly described above can be used with a different design of pump than the one described—other designs of pump may be configured to cause reciprocating movement of fluid in one or more fluid-containing lines. In other words, the particular pump described is not essential to the motor. Similarly, the fluid pump described above can be used to drive a different design of fluid motor than the one described—other designs of fluid motor may be configured to be driven by reciprocating movement of fluid in one or more fluid-containing lines.

It is well known for a fluid pump to drive circulation of a fluid. The fluid pump described above may be modified for a circulatory fluid system by having separate inlet and outlet apertures to the chambers with coupled fluid transmission lines. Similarly, the fluid motor may be modified to be driven by circulating fluid by modifying each fluid chamber having separate inlet and outlet apertures coupled to fluid transmission lines. The hub assembly described above may be modified to be driven by circulating fluid. Such circulatory fluid systems may include an accumulator, and supply of fluid to the fluid motor may be regulated using a regulation system including the accumulator. The fluid pump described herein may be implemented with a fluid motor described in WO2014195666, the disclosure of which is herein incorporated by reference. The fluid motor described herein may be implemented with a fluid pump described in this document. This document describes separately hydraulic systems in which fluid reciprocates/pulsates in lines and in which fluid circulates.

The applicant hereby discloses in isolation each individual feature or step described herein and any combination of two or more such features, to the extent that such features or steps or combinations of features and/or steps are capable of being carried out based on the present specification as a whole in the light of the common general knowledge of a person skilled in the art, irrespective of whether such features or steps or combinations of features and/or steps solve any problems disclosed herein, and without limitation to the scope of the claims. The applicant indicates that aspects of the present invention may consist of any such individual feature or step or combination of features and/or steps. In view of the foregoing description it will be evident to a person skilled in the art that various modifications may be made within the scope of the invention.

1. A hub assembly comprising a fluid motor for a fluid pressure system, the fluid motor comprising:
at least two piston assemblies each comprising a piston, the at least two pistons assemblies being operable to cause sequential reciprocating movement of the pistons;
a drive member rotatable about an axis and providing an annular, wave-like surface extending at least partially radially to the axis, towards which the pistons project, wherein the pistons means are arranged to drive rotation of the drive member about the axis at least by a pushing action on said wave-like surface.

2. The hub assembly of claim 1, wherein the at least two piston assemblies comprise or consist of three piston assemblies.

3. The hub assembly of claim 1, wherein each piston assembly further comprises a cylinder, wherein each cylinder and an end of the respective piston defines a chamber, wherein each piston is operable to cause reciprocating movement of the respective piston by movement of fluid into and out of the respective chamber.

4. The hub assembly of claim 1, further comprising a shaft, wherein the shaft is coaxial with the drive member and the drive member is mounted for rotation about said shaft.

5. The hub assembly of claim 1, wherein the wave-like surface extends continuously around the axis and at least partially faces in a direction parallel to the axis.

6. The hub assembly claim 1, wherein the wave-like surface has at least one peak and one trough.

7. The hub assembly of claim 6, wherein the wave-like surface has at least two peaks and two troughs.

8. The hub assembly of claim 1, further comprising a sleeve extending around the drive member coaxially therewith, wherein the drive member and the sleeve are configured to cooperate so that the rotation of the drive member drives rotation of the sleeve means.

9. (canceled)

10. The hub assembly of claim 8, wherein the sleeve is coupled to a rim of a wheel.

11. A wheel comprising the hub assembly of claim 1.

12. A fluid pressure system comprising the fluid motor of claim 1, and a fluid pump coupled to the fluid motor to cause sequential reciprocating movement of the pistons.

13. A fluid pump for a fluid pressure system, comprising:
a drive member rotatable about an axis by a pedaling action and providing an annular, wave-like surface extending at least partially radially to the axis,
at least two piston assemblies each comprising a piston means, wherein the pistons means project towards the wave-like surface, wherein the at least two piston assemblies and the wave-like surface are arranged to cooperate so that rotation of the drive member about the axis drives sequential reciprocating motion of the piston means at least by a pushing action by the wave-like surface on said piston means.

14. The fluid pump of claim 13, wherein the at least two piston assemblies comprise or consist of three piston assemblies.

15. The fluid pump of claim 13, wherein each piston assembly is operatively coupled to a respective pressure transmission line containing fluid and is arranged so that reciprocating movement of the respective piston at least in part causes reciprocating movement of the fluid in the respective pressure transmission line.

16. The fluid pump of claim 13, wherein each piston assembly is operatively coupled to a fluid transmission system containing fluid, wherein the reciprocating movement of the piston drives flow of the fluid in the fluid transmission system.

17. The fluid pump of claim 13, wherein each piston assembly further comprises a cylinder, wherein each cylinder and an end of the respective piston define a chamber, wherein each piston assembly is operable to drive movement of the fluid into and out of the chamber.

18. The fluid pump of claim 13, further comprising a drive shaft, wherein the drive shaft is coaxial with the drive member, wherein the drive shaft and the drive member are coupled so that rotation of the drive shaft drives rotation of the drive member.

19. The fluid pump of claim 13, wherein the wave-like surface extends continuously around the axis and at least partially faces in a direction parallel to the axis.

20. The fluid pump of claim 13, wherein the wave-like surface has at least one peak and at least one trough.

19. (canceled)

21. A fluid pressure system comprising: a fluid pump of claim 13, and a fluid motor having at least one further piston assembly each including at least one further piston, wherein the fluid pump is coupled to the fluid motor so that sequential reciprocating movement of the piston of the fluid pump drives sequential movement of the at least one further piston.

22. The hub assembly of claim 10, wherein the wheel is a bicycle wheel.

23. A hub assembly comprising a fluid motor for a fluid pressure system, the fluid motor comprising:
at least two piston assemblies each comprising a piston means, the at least two piston assemblies being operable to cause sequential reciprocating movement of the pistons means;
a drive member rotatable about an axis and providing an annular, wave-like surface extending at least partially radially to the axis, towards which the piston means project, wherein the pistons means are arranged to drive rotation of the drive member about the axis at least by a pushing action on said wave-like surface.
